(19) United States
(12) Patent Application Publication
(10) Pub. No.: US 2006/0284866 A1
(43) Pub. Date: Dec. 21, 2006

(54) Method and device for the generation of specific elements of an image and method and device for the generation of overall images comprising said specific elements

(75) Inventors: Henri Fousse, Nogent Sur Marne (FR); Yaan Menguy, Paris (FR); Domonique Pierre, Jouy Le Moutier (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: THALES, Neuilly Sur Seine (FR)

(21) Appl. No.: 10/567,969

(22) PCT Filed: Jun. 30, 2004
(86) PCT No.: PCT/EP04/51302

§ 371 Date: Feb. 10, 2006

(30) Foreign Application Priority Data
Aug. 13, 2003 (FR) 03/09910

(51) Int. Cl. G06T 1/00

(52) U.S. Cl. 345/418

(57) ABSTRACT

The invention relates to a method and device for generation of specific elements with characteristics different to those of the majority of generic elements of an image, in particular, image points with a resolution, a positional precision and a contrast greater than for the rest of the image. The invention also relates to a method and a device for the generation of artificial images using said method for generation of specific elements and a flight simulator using said device. Conventional methods for the generation of artificial images with image points comprised of specific elements are not immediately transferable and, furthermore, are complex and costly. According to the invention, the separation of the method for generating generic elements, in particular, elements of the observed image, from the method for the generation of the specific elements, in particular, the image points, permits the use of a commercially-available graphics card for the generation of the generic elements and the separate application of said two methods for generic elements and specific elements on normal computers, for example of the PC type.

The invention relates to a method and a device for generating specific elements having characteristics different from those of the majority of the generic elements of an image, in particular of calligraphic light points having a resolution, a positional accuracy and a contrast greater than the rest of the image. It also relates to a method and a device for generating overall images using the method of generating specific elements, and a flight simulator using this device, in particular aircraft simulators that can be certified at the highest level of qualification by the official bodies.

In a visual airplane or helicopter simulator system, the representation of the runway lights must be extremely accurate and realistic in order to satisfy the pilot training requirements, as defined by the current regulations (level D of the circulars FAA AC120-40B and JAR STD 1A). The resolution of these lights, their positional accuracy and their contrast relative to the rest of the scene outstrip the capability of the current “raster” mode controlled projectors (television type scanning).

This display is therefore produced by dedicated projectors sequentially displaying the visual scene made up, for example, of polygons (runways, buildings, ground, etc.), in a so-called TV mode, then finally, the runway lights with a particular so-called calligraphic mode in which the spot can be positioned in the x-y frame of reference anywhere in the image and remain there for the time required to obtain the required brightness. This mode provides for both extremely bright lights and lights positioned with a very high accuracy. Such lights are called calligraphic light points or even light points.

These days, for such flight simulator applications, dedicated image generation machines are used, that are complex and costly (more than 100 000 ε per visual channel). Reducing the costs and the complexity of the overall image generation devices for such applications including calligraphic light points could be envisaged by using the latest consumer graphics cards. In practise, these consumer graphics cards offer a performance level and image quality that would satisfy FAA/JAA certification requirements. However, these consumer graphics cards cannot be used to generate calligraphic light points.

In the current architecture of an overall image generator, the pixel processor computes the brightness of the calligraphic light points after having computed the brightness of the pixels of the 2D image. The brightness information of each of the lights is then linked to its 2D coordinates for display on the projector in calligraphic mode. This method is made possible because the depth information relative to the observation position is directly available on the card (Z-buffer, range buffer or equivalent type algorithm).

Therefore, in the current overall image generation devices, the problem of managing the calligraphic light points and, in particular, their possible masking by other elements in the scene, has been introduced at design level. Such an integration at the design stage in the consumer graphics cards cannot be envisaged. In a market-standard graphics card for PCs, the geometric processor and the pixel processor are integrated on the graphics processor of the card. It is normally not possible, without the support of the card manufacturer, even of the graphics processor manufacturer, to access the depth information with which to manage masking situations.

This introduces a dependency with regard to manufacturers. Now, the manufacturers of this type of card are not interested in the simulation market, in particular at the higher level of the FAA/JAA standards. This lack of interest is linked to the fact that it is too narrow a technological niche, representing a market of only a hundred or so channels per year.

Furthermore, the current solution is specific to the graphics processor used and is not, therefore, immediately portable. The use of a new card equipped with a different graphics processor then requires a modification of the calligraphic light point computation.

The present invention seeks to overcome these drawbacks by separating the method of generating generic elements, in particular elements of the observation scene, from the method of generating specific elements, in particular calligraphic light points, so making it possible to use consumer graphics cards for the generation of the generic elements and for the separate implementation of these two generic element and specific element methods on conventional computers, such as PCs.

One subject of the invention is a method of generating specific elements having characteristics different from those of the majority of the generic elements of an image such that the generation of these specific elements is performed independently of the generation of the generic elements of the image.

In addition, the method of generating specific elements according to the invention can include the determination of the impact of these generic elements on the specific elements.

Furthermore, the determination of the impact on the specific elements can include, for each specific element:
the classification of the generic elements as generic elements to be tested if these generic elements are contained by a subdivision of the vision pyramid defined by the observation point including the specific element,
the determination of the generic elements having an impact on at least one specific element by scanning through all the generic elements to be tested in order to determine if one of these generic elements is intersected by the straight line passing through the observation point and the specific element,
the computation of the impact on the specific element from the generic element determined as having an impact,
the classification of the generic elements can be used to reduce the required computing power.

The invention also proposes a device for generating specific elements implementing the method of generating specific elements above, including means of determining the impact of the generic elements on the specific elements.

Another subject of the invention is a method of generating overall images including specific elements having characteristics different from those of the majority of the generic elements of the images, characterized in that it includes:
on a first channel:
   extraction of the N-dimensional coordinates (N being an integer greater than or equal to 3) of the generic elements, from the observation point provided and a visual database,
   the computation of the 2D image according to the generic coordinates extracted;
on a second channel, the method of generating specific elements described above.

The invention further relates to a device for generating overall images including:
on a first channel, means of generating generic elements implementing the extraction of the generic elements and the computation of the 2D image of the above method of generating overall images;
on a second channel, means of generating specific elements implementing the method of generating specific elements described above.

The invention can be used by a flight simulator which therefore includes the above device for generating overall images.

The characteristics and advantages of the invention will become more clearly apparent from reading the description, given as an example, and the related figures which represent:

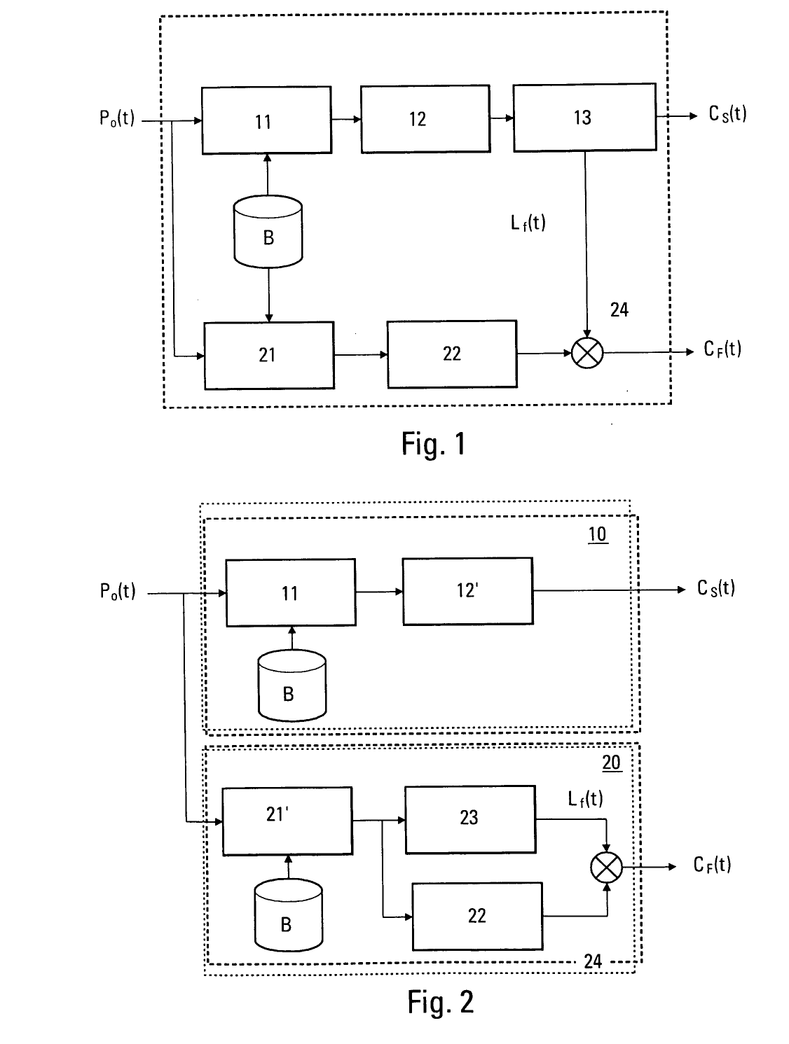

FIG. 1, an example of current architecture of the method of generating overall images with calligraphic light points according to the state of the art,

FIG. 2, an example of architecture of the method of generating overall images with specific elements according to the invention,

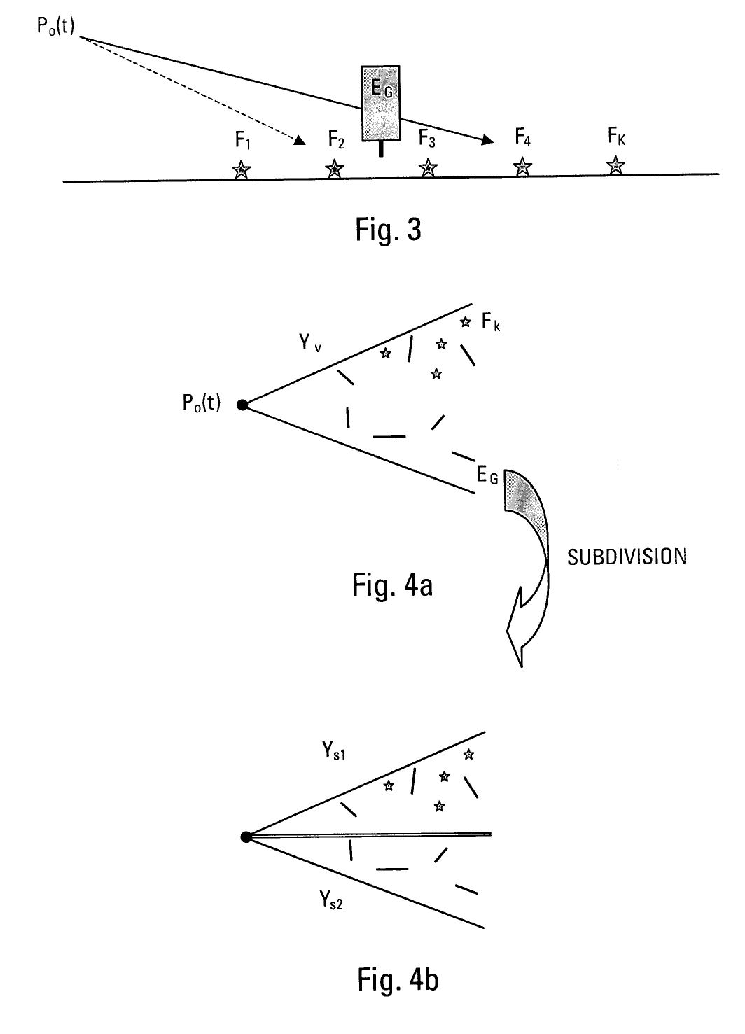

FIG. 3, the principle of the so-called “ray tracing” method implemented by the method of determining impact of generic elements on specific elements,

FIGS. 4a and 4b, the principle of classification of the generic elements by subdivision of the vision pyramid according to the invention: FIG. 4a showing a pyramid before subdivision and FIG. 4b after a first subdivision.

The aim of the method according to the invention is to generate specific elements F of overall images. To reproduce these specific elements F, the projector is interfaced via a dedicated graphics card in order to control the projector in this specific mode. The specific elements F of an overall image are differentiated from the generic elements E_{G} of the image in that they have different reproduction characteristics from the generic elements E_{G}. These different characteristics are, for example, that the resolution, and/or the accuracy, and/or the contrast of these specific elements F are greater than those of the generic elements E_{G}.

In the following examples, the generic elements E_{G} of the image will be made up of polygons and the specific elements F of calligraphic light points. The specific mode will, then, be the calligraphic mode and the generic mode will be the TV mode. These examples can be transposed to any type of generic elements E_{G}: dots, segments, polyhedra, etc., and to any type of specific elements.

In the current architecture represented by FIG. 1, the method of generating overall images is implemented by a complex image generator.

This complex image generator has two channels:
the first channel for the TV mode providing the control instructions C_{S}(t) for the graphics card interfacing the projector to reproduce the observation scene,
the second channel for the calligraphic mode providing the control instructions C_{F}(t) for the specific graphics card interfacing the projector to reproduce the calligraphic light points F.

From the observation position Pₒ(t), the 3D coordinates of the visual scene (of the generic elements) E_{G} are extracted by extraction means 11 from a visual database B. Initially, the 2D geometry of the image corresponding to the scene and of the calligraphic light points in the observation window defined by the observation point Pₒ(t) is computed, for example, by a geometric processor 12. Secondly, the masking and the brightness of the calligraphic light points L_{f}(t), are computed after having computed the brightness of the pixels of the 2D image C_{S}(t), for example, by the pixel processor 13. The brightness of the pixels of the 2D image C_{S}(t) is transmitted to a graphics card (not shown) to control the projector (not shown) in TV mode.

Again from the observation position Pₒ(t), the 3D coordinates of the calligraphic light points (of the specific elements) F are extracted from the visual database B by light extraction means 21. Firstly, the 3D coordinates of the calligraphic light points F in the observation window defined by the observation point Pₒ(t) are converted into 2D coordinates by conversion means 22. Secondly, the brightness information of each of the lights L_{f}(t) computed by the first channel is then linked by association means 24 to its 2D coordinates determined by the second channel for display on the projector in calligraphic mode. This method is made possible because the depth information relative to the observation point is directly available on the card (Z-buffer, range buffer or equivalent type algorithm).

In order to reduce the costs and complexity of the generators of overall images with specific elements, such as, in particular, calligraphic light points, the invention proposes a new architecture of the method of generating such images and, in particular, of generating specific elements, which has the advantage of making the generation of the specific elements independent of the generation of the generic elements. Thus, by separating the generation of specific elements 20 from the generation of generic elements 10, the use of consumer graphics cards and computers is made possible.

The new architecture proposed in FIG. 2 therefore allows for the completely independent computation of the TV image and the calligraphic light points. The main advantage of this solution is that it makes it possible to follow the continually improving performance levels of the graphics processors by using the most powerful graphics card of the time without modifying the computation of the calligraphic light points.

The method of generating specific elements that is the subject of the invention is illustrated by the second channel of FIG. 2.

Extraction means 21′ extract from the visual database B, from the observation position Pₒ(t), the 3D coordinates not only of the specific elements F, the calligraphic light points in our example, as in the prior art, but also of the generic elements E_{G}, the polygons forming the scene in our example. The 3D coordinates extracted from the specific elements F are converted into 2D by conversion means 22, and the impact of the generic elements on the specific elements, the brightness of the calligraphic light points according to the masking in our example, L_{f}(t), is determined by impact determination means 23. The association means 24 receive the 2D coordinates of the lights from the conversion means 22 and the brightness information for each of the lights L_{f}(t) computed by the impact determination means 23.

To implement such a method of generating specific elements, the second channel or calligraphic channel can include one or more PC or equivalent computers, synchronized With the preceding one, having a copy of the database B and computing the masking situations by a method of determining the impact of the generic elements on the specific elements implemented 23 for example, in a purely software form. This method of determining the impact of the generic elements on the specific elements 23 is described in greater detail below.

A card in PCI or equivalent format provides the interface with the calligraphic input of the projector. It is also used to generate special atmospheric effects by defocusing the lights. This card is simple and inexpensive, it can be set up by programming an FPGA according to the projector used.

The method of generating overall images including specific elements proposed by the invention therefore includes, on a first channel or graphics TV channel, a method of generating generic elements 10 including:
the extraction 11 of the N-dimensional coordinates (N being an integer greater than or equal to 3) of the generic elements E_{G}, from the observation point provided Pₒ(t) and a visual database B,
the computation 12′ of the 2D image according to the generic coordinates E_{G} extracted.

This graphics TV channel can include a PC or equivalent with unmodified market-standard graphics card.

This new architecture makes it possible to use one or more machines according to the required performance levels and the commercially available technologies, and it therefore presents a very high level of scaling flexibility. A visual system that does not have the calligraphic function can now easily be modernized using this solution, and without compromising the existing architecture.

Thus, the device for generating overall images including means (10) of generating generic elements (E_{G}) and means (20) of generating specific elements (F) can include:
either a single first processor (not shown) including both means (20) of generating specific elements (F) that can be interfaced with at least one projector via an electronics card and means (10) of generating generic elements (E_{G}),
or a first processor including means (20) of generating specific elements (F) that can be interfaced with at least one projector via an electronics card, and a second processor including means (10) of generating generic elements (E_{G}).

Said first processor possibly including the generic mode graphics card.

Furthermore, the flexibility of the solution for separating the two channels illustrated by FIG. 2 makes it possible to produce special effects based on the use of the calligraphic light points, such as the reflection of the lights on a wet runway in a very realistic way, whereas this is virtually impossible with a conventional solution.

The invention also relies on the determination of the impact of the generic elements on the specific elements, for example, by a masking algorithm that is very powerful in terms of computing power, that can be run on a PC type conventional computer.

The computation of the masking, relative to an observer, of a point belonging to a visual scene is very costly in terms of computing power required with a conventional solution and requires a dedicated computer card, coupled with the rest of the image generator.

The method of determining impact, in particular masking, described above, considerably reduces the computing power required through its design suited to the problem posed, that is, the masking of light points. The training requirements set at around 5000 the number of lights to be computed per graphics channel within an allotted computation time of less than 25 ms.

The method used to determine whether the generic elements have an impact on the specific elements (in particular, whether the calligraphic light points are seen or masked) is based on the “ray tracing” method.

The determination of the generic elements (E_{G}) having an impact on at least one specific element is performed by scanning all the generic elements (E_{G}) to be tested in order to determine whether one of these generic elements (E_{G}) is intersected by the straight line passing through the observation point and the specific element.

In our example, the image is made up of generic elements E_{G} comprising polygons and of specific elements (lights) represented by stars. The ray tracing principle presented by FIG. 3 consists in defining, for each light, the straight line passing through the observation point Pₒ(t) and this light Fₖ(1≦k≦K), and in scanning all the polygons of the image to determine whether one of them is intersected by the straight line (and therefore masks the light concerned). However, given the very high number of polygons and of lights present in the images processed routinely, the ray tracing method described above would inevitably lead to an exponential number of computations making this method expensive in terms of computation cost.

In order to reduce the computing cost of the impact determination method, the ray tracing principle can be retained while also implementing a classification of the rays with which to vastly reduce the number of intersections computed.

This classification of the generic elements (E_{G}) makes it possible to discard as generic elements (E_{G}) to be tested the generic elements (E_{G}) contained by a subdivision of the vision pyramid defined by the observation point including the specific element as illustrated by FIGS. 4a and 4b.

Thus, the impact determination method using the classification makes it possible to avoid an exhaustive processing of the straight line/polygon intersections, that is very costly, by constructing on each cycle a classification of these elements according to their position relative to the observer. This classification is made by subdividing the vision pyramid, which in many cases means that certain polygons, that are known not to be able to mask any lights, no longer need to be tested.

In the example illustrated by FIGS. 4a and 4b, the subdivision of the vision pyramid Yᵥ of the FIG. 4a leads to two sub-pyramids Yₛ₁ and Yₛ₂ of FIG. 4b. In the case illustrated by FIG. 4b, the classification makes it possible to note that one of the sub-pyramids Yₛ₂ contains no light Fₖ (the lights being represented by stars), and that it is therefore pointless to take account of all the polygons E_{G} (represented by straight line segments) that it contains.

This subdivision principle, applied with a number of iterations, can be used to obtain a partition of the vision pyramid Yᵥ in tree form and, ultimately, to considerably reduce the number of straight line/polygon intersections computed.

Having thus determined, more quickly thanks to the classification, the generic element E_{G} having an impact on a given specific element Fₖ, the impact is computed (for example, the resultant brightness in the case of a total or partial masking, the defocusing in the case of atmospheric effects, the optical reflection in the case of a reflection on a generic element such as, in particular, a wet surface, etc).

The novelty of the impact determination method with classification relies on four factors:
The data structure is thus optimized.
The classification of the traced rays considerably reduces the number of intersections computed.
Some of the processes can be performed asynchronously, because the results do not vary rapidly. They correspond to a first reduction of the list of elements that can have an impact on the calligraphic light points.
The computation of the impact proper is performed synchronously.

Thus, the classification and the determination of the generic elements (E_{G}) having an impact can be carried out asynchronously, and the computation of the impact can be carried out synchronously.

The present impact determination method with classification can be used to process all operational operating cases, including, in particular, cases of masking by moving objects in the scene (vehicles on the ground or air traffic) or by semi-transparent or textured faces, such as cloud layers, for example.

The present impact determination method with classification can be used to divide by approximately 10 the computing power needed compared to the conventional algorithms used today.

The device for generating overall images with calligraphic light points enables the calligraphic light points to be processed by a purely software solution running on market-standard hardware, using a ray tracing algorithm to compute the masking of the calligraphic light points, with:
An optimized data structure and a classification of the traced rays to reduce the number of intersections computed.
Some of the masking computations performed asynchronously and the computation of the masking proper performed synchronously.

Flight simulators equipped with such a device for generating overall images implementing the specific element generation method of the invention satisfy current regulations. In particular, the impact determination method with classification satisfies certain masking and reflection-related requirements in these regulations.

The present invention therefore relates to a new architecture comprising two separate channels corresponding, respectively, to the generic and specific modes, enabling the use of consumer graphics cards and the implementation of light masking computations on PC type market-standard computers, so saving on development and on the purchase of dedicated graphics cards that are still very expensive.

1-14. (canceled)

15. A method of generating specific elements having characteristics different from those of the majority of the generic elements of an image, comprising the steps of performing the generation of these specific elements independently of the generation of the generic elements of the image.

16. The method of generating specific elements as claimed in the claim 15, wherein said performing step includes the determination of the impact of these generic elements on the specific elements.

17. The method of generating specific elements as claimed in the claim 16, wherein the determination of the impact on the specific elements includes, for each specific element:
the classification of the generic elements as generic elements to be tested if these generic elements are contained by a subdivision of the vision pyramid defined by the observation point including the specific element,
the determination of the generic elements having an impact on at least one specific element by scanning through all the generic elements to be tested in order to determine if one of these generic elements is intersected by the straight line passing through the observation point and the specific element,
the computation of the impact on the specific element from the generic element determined as having an impact.

18. The method of generating specific elements as claimed in the claim 17, wherein the classification and the determination of the generic elements having an impact are performed asynchronously, and in that the computation of the impact is performed synchronously.

19. The method of generating specific elements as claimed in the claim 17, wherein the impact includes a total or partial masking, or of an atmospheric effect, or of a reflection.

20. The method of generating specific elements as claimed in the claim 16, wherein it includes:
the extraction of the N-dimensional coordinates of the specific elements and of the generic elements, from an observation point provided Pₒ(t) and a visual database,
the determination of the impact from the extracted coordinates,
the conversion of the coordinates of the specific elements into a predetermined M-dimensional format,
the association with these M-dimensional coordinates of the determined impact, providing coordinates and generation characteristics of the specific elements C_{F}(t).

21. The method of generating specific elements as claimed in the claim 15, wherein the specific elements correspond to the elements displayed in a calligraphic mode and the generic elements correspond to the elements displayed in a TV mode.

22. A device for generating specific elements implementing the method of generating specific elements as claimed in the claim 15, wherein said device includes means of determining the impact of the generic elements on the specific elements.

23. A method of generating overall images including specific elements having characteristics different from those of the majority of the generic elements of the images, comprising the steps of:
extraction of the N-dimensional coordinates of the generic elements, from the observation point provided Pₒ(t) and a visual database,
the computation of the 2D image according to the generic coordinates extracted;
on a second channel, the method of generating specific elements having characteristics different from those of the majority of the generic elements of an image, performing the generation of these specific elements independently of the generation of the generic elements of the image.

24. A device for generating overall images including:
on a first channel, means of generating generic elements implementing the extraction of the generic elements and the computation of the 2D image of the method of generating overall images including specific elements having characteristics different from those of the majority of the generic elements of the images, including:
extraction of the N-dimensional coordinates of the generic elements, from the observation point provided Pₒ(t) and a visual database,
the computation of the 2D image according to the generic coordinates extracted;
on a second channel, the method of generating specific elements having characteristics different from those of the majority of the generic elements of an image, performing the generation of these specific elements independently of the generation of the generic elements of the image.
on a second channel, the device for generating specific elements implementing the method of generating specific elements having characteristics different from those of the majority of the generic elements of an image, performing the generation of these specific elements independently of the generation of the generic elements of the image, including means of determining the impact of the generic elements on the specific elements.

25. The device for generating overall images as claimed in the claim 24, wherein it includes at least one first processor including means of generating specific elements that can be interfaced with at least one projector via an electronic card, said first processor including said card.

26. The generation device as claimed in claim 25, wherein it includes a second processor including means of generating generic elements.

27. The generation device as claimed in claim 25, wherein said first processor also includes the means of generating generic elements.

28. A flight simulator, wherein said first simulator includes a device for generating overall images as claimed in claim 22.
